(19) United States
(12) Patent Application Publication
(10) Pub. No.: US 2005/0111356 A1
(43) Pub. Date: May 26, 2005

(54) Connection controller

(76) Inventor: Mark Andrew Whittaker Stewart, Melbourne (AU)

Correspondence Address: MOTOROLA, INC., Corporate Law Department - #56-238, 3102 North 56th Street, Phoenix, AZ, 85018, US

(21) Appl. No.: 10/722,021

(22) Filed: Nov. 25, 2003

(51) Int. Cl. H04L 1/00

(52) U.S. Cl. 370/229

(57) ABSTRACT

A connection controller (402) includes a network topology cache (418) coupled to receive network topology data (405) of a network (400). Connection controller also can include a packing algorithm (414) coupled to receive a requested traffic pattern (403) of a packet (408), where the packing algorithm computes an actual traffic pattern (412) using the network topology data and the requested traffic pattern such that the network operates as a strictly non-interfering network (419). Connection controller further includes a logical network state entity (420) coupled to communicate the actual traffic pattern to a source (406) corresponding to the packet.

### RELATED CASES

Related subject matter is disclosed in U.S. patent application entitled “METHOD OF OPERATING A CLOS NETWORK” having application Ser. No. ______ and filed on the same date herewith and assigned to the same assignee.

Related subject matter is disclosed in U.S. patent application entitled “INFINIBAND SWITCH OPERATING IN A CLOS NETWORK” having application Ser. No. ______ and filed on the same date herewith and assigned to the same assignee.

Related subject matter is disclosed in U.S. patent application entitled “STRICTLY NON-INTERFERING NETWORK” having application Ser. No. ______ and filed on the same date herewith and assigned to the same assignee.

### BACKGROUND OF THE INVENTION

Current switching topologies for network operations can cause a network to suffer performance degradation due to latency. Significant delays from latency can result from queuing delays in network switches due to interference caused by competing traffic sources attempting to use the same network resources at the same time. This can cause packets to queue up in one or more switches and delay the packet's delivery to its destination. This increase in latency slows network response time and can result in lost packets and other disadvantageous network behavior.

Accordingly, there is a significant need for an apparatus and method that overcomes the deficiencies of the prior art outlined above.

### BRIEF DESCRIPTION OF THE DRAWINGS

Referring to the drawing:

FIG. 1 depicts a network according to one embodiment of the invention;

FIG. 2 depicts a network according to another embodiment of the invention;

FIG. 3 depicts a network according to yet another embodiment of the invention;

FIG. 4 depicts a block diagram of a network according to an embodiment of the invention;

FIG. 5 illustrates a flow diagram of a method of the invention according to an embodiment of the invention;

FIG. 6 illustrates a flow diagram of a method of the invention according to another embodiment of the invention; and

FIG. 7 illustrates a flow diagram of a method of the invention according to yet another embodiment of the invention.

It will be appreciated that for simplicity and clarity of illustration, elements shown in the drawing have not necessarily been drawn to scale. For example, the dimensions of some of the elements are exaggerated relative to each other. Further, where considered appropriate, reference numerals have been repeated among the Figures to indicate corresponding elements.

### DESCRIPTION OF THE PREFERRED EMBODIMENTS

In the following detailed description of exemplary embodiments of the invention, reference is made to the accompanying drawings that illustrate specific exemplary embodiments in which the invention may be practiced. These embodiments are described in sufficient detail to enable those skilled in the art to practice the invention, but other embodiments may be utilized and logical, mechanical, electrical and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known circuits, structures and techniques have not been shown in detail in order not to obscure the invention.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact. However, “coupled” may mean that two or more elements are not in direct contact with each other, but yet still co-operate or interact with each other.

For clarity of explanation, the embodiments of the present invention are presented, in part, as comprising individual functional blocks. The functions represented by these blocks may be provided through the use of software, or shared or dedicated hardware, including, but not limited to, hardware capable of executing software. The present invention is not limited to implementation by any particular set of elements, and the description herein is merely representational of one embodiment.

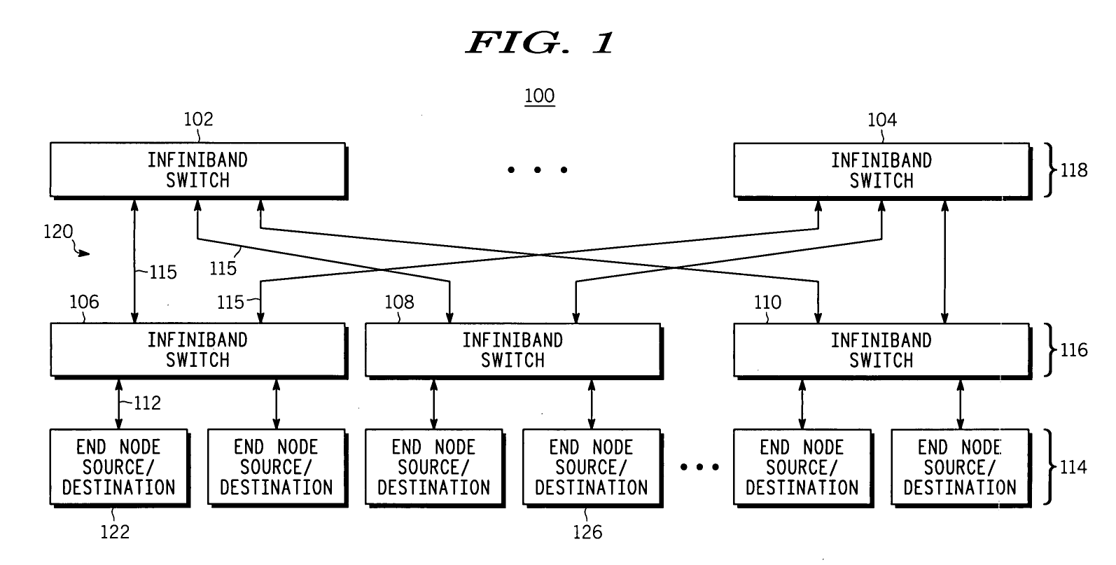

FIG. 1 depicts a network 100 according to one embodiment of the invention. In an embodiment, network 100 can be implemented in one or more chassis in a backplane-type interconnect environment. In another embodiment, network 100 can be implemented on the same switching board or switching chip. Network 100 may utilize a packet data protocol for traffic movement among switches and end-node devices. For example, network 100 may use InfiniBand. InfiniBand is specified by the InfiniBand™ Architecture Specification, Release 1.1 or later, as promulgated by the InfiniBand™ Trade Association, 5440 SW Westgate Drive, Suite 217, Portland, Oreg. 97221. As such, network 100 utilizes data packets having fixed or variable length, defined by the applicable protocol.

The network 100 depicted in FIG. 1 includes first stage InfiniBand switches 116 coupled to second stage InfiniBand switches 118 by a plurality of links 115. In an embodiment, each of plurality of links 115 can be bi-directional. In an embodiment, plurality of links 115 operated under InfiniBand can be 1×, 4× or 12× speed links. In an embodiment, each of first stage InfiniBand switches 116 can be coupled to one or more of a plurality of end nodes 114. Each of plurality of end nodes 114 can be, for example and without limitation, application servers, database servers, and the like. In an embodiment, each of plurality of end nodes 114 can act as a source (i.e. creating a packet and placing it in network 100), or a destination (an end point for a packet created by a source). In another embodiment, one or more of each of plurality of end nodes 114 can act as both a source for one packet, and as a destination for another packet. For example, source 122 can create a packet with a destination 126. In an embodiment, network 100 is a non-blocking network.

In an embodiment, two or more first stage InfiniBand switches 116 may be implemented within a single switching entity, for example a single switching chip, physical switching unit, and the like. Also, two or more of second stage InfiniBand switches 118 may be implemented within a single switching entity. In yet another embodiment, two or more Infiniband switches may be functionally replaced with either a single Infiniband switch or a subnetwork with a non-blocking topology. In an exemplary embodiment of the invention, network 100 can be built using any number of InfiniBand switches, where an InfiniBand switch can be a 24-port Mellanox Anafa-II InfiniBand Switch, manufactured by Mellanox Technologies, 2900 Stender Way, Santa Clara, Calif. 95054. The invention is not limited to the use of this switch and another type or model of InfiniBand switch may be used and be within the scope of the invention.

The plurality of links 115 can use, for example and without limitation, 100 ohm differential transmit and receive pairs per channel. Each channel can use high-speed serialization/deserialization (SERDES) and 8b/10b encoding.

In network terminology, admissible traffic patterns are traffic patterns in an InfiniBand network where the traffic entering the InfiniBand network does not exceed the InfiniBand network's ability to output traffic. Interference in a network occurs when competing traffic sources attempt to use the same network resources at the same time. This can result in a degradation of the sustained rate of data transfer which one or more of the sources can maintain. It will either result in an increased latency or packet loss. In a network operating using InfiniBand, link flow control algorithms guarantee that short-term congestion will not result in packet loss. Therefore, in a network operating using InfiniBand, short-term congestion will manifest itself as increased data transfer latency.

A non-interfering network (i.e. a network without interference) is a network for which the performance degradation for any admissible traffic pattern is guaranteed to conform to a pre-specified bound. This bound can be either deterministic or statistical. For example, a network can be deemed non-interfering if the worst-case end-to-end latency is guaranteed to be less than ten microseconds. This is an example of a deterministic bound. As another example, a network can be deemed non-interfering if 99% of packets experience network latencies of less than two microseconds. This is an example of a statistical bound. These are just examples and are not limiting of the invention. The appropriate choice for a pre-specified bound is application specific, and a network supporting multiple applications can impose different bounds on performance on each traffic type.

A strictly non-interfering network (SNIN) is a network for which the only queuing delays experienced by an admissible traffic pattern are attributable to the multiplexing of packets from slow links onto a faster link whose aggregate bandwidth at least equals the sum of the bandwidths of the smaller links. In a SNIN, competing traffic sources do not attempt to use the same network resources at the same time. The implementation of a SNIN requires that resources be dedicated through the network in support of an active communication session. In order to accomplish this, non-blocking networks can be used.

A network is non-blocking if it has adequate internal resources to carry out all possible admissible traffic patterns. There are different degrees of non-blocking performance based upon the sophistication of the control policy required to achieve non-blocking performance.

Most network switching applications allow the establishment of new connections and the tear down of old ones. It is possible that for a network with a non-blocking topology, a new connection can be blocked due to poor or unfortunate assignment of previously established connections. A strictly non-blocking network is a network for which any new admissible connection may be accepted independent of the state of preexisting connections, or the policy used to reroute preexisting connections, without changing the routes of the preexisting connections. A crossbar network is an example of a strictly non-blocking network. As another example, a rearrangably non-blocking network is a network that may be augmented by a mechanism to reroute preexisting connections such that it is possible to carry the preexisting connections and any new admissible connection.

Another type of non-blocking network is a Clos network. Clos networks are known in the art. For example, see “A Study of Non-Blocking Switching Networks” by Charles Clos, Bell System Technical Journal, 1953, vol. 32, no. 2, pp. 406-424. In an embodiment, Clos networks can include FAT trees and K-nary arrays, other non-blocking networks, and the like. In an embodiment, network 100 is a Clos network 120. In an embodiment, Clos network 120 can be a two stage hierarchical network in which each node in the first stage connects to each node in the second stage through a plurality of links 115. In the embodiment shown in FIG. 1, first stage InfiniBand switches 116 can be considered the first stage and second stage InfiniBand switches 118 can be considered the second stage.

As an illustration of an embodiment of the invention, traffic can traverse network 100. Traffic (i.e. a packet) originating at end node 122 can enter InfiniBand switch 106 through an end-node port 112, passes through an internal switch link. The packet proceeds to one of second stage InfiniBand switches 118, for example InfiniBand switch 102, via one of plurality of links 115 (where plurality of links 115 are bi-directional). The packet crosses through internal switch link at InfiniBand switch 102, and back to one of first stage InfiniBand switches 116, for example InfiniBand switch 108, via one of plurality of links 115. The packet can then proceed to an end node coupled to InfiniBand switch 108, for example end node 126.

Although only one of plurality of links 115 is shown between each first stage InfiniBand switches 116 and second stage InfiniBand switches 118, the invention is not limited to only one link. In other embodiments there can be more than one of plurality of links 115 between each of first stage InfiniBand switches 116 and each of second stage InfiniBand switches 118.

The number of plurality of links 115 between each pairing of first stage InfiniBand switches 116 and second stage InfiniBand switches 118 compared to the number of end-node ports on each of first stage InfiniBand switches 116 determines the degree of blocking potentially experienced by traffic crossing Clos network 120. For example, if the number of second stage InfiniBand switches 118 is greater than or equal to the number of end node ports 112 on a first stage InfiniBand switch 116, then Clos network 120 is a rearrangably non-blocking Clos network. As explained above, network 100 is non-blocking if it has adequate internal resources to carry out all admissible traffic patterns. As another example, Clos network 120 is strictly non-blocking if the number of second stage InfiniBand switches 118 is equal to or greater than 2*(number of end-node ports 112)−1.

Although FIG. 1 depicts a two stage hierarchical network, which can be a Clos network 120, this is not limiting of the invention. Network 100, and Clos network 120 can have any number of hierarchical stages and be within the scope of the invention. In other words, multistage networks and multistage Clos networks are within the scope of the invention.

Although FIG. 1 depicts three first stage InfiniBand switches 116, specifically, InfiniBand switches 106, 108, 110, and two second stage InfiniBand switches 118, specifically InfiniBand switches 102, 104, any number of first stage InfiniBand switches 116 and second stage InfiniBand switches 118 are within the scope of the invention. Also, any number of end-node ports 112 are within the scope of the invention. Further, any number of switch interlink ports coupling InfiniBand switches to each other via plurality of links 115 are within the scope of the invention. Still further, any number of plurality of end nodes 114 are within the scope of the invention.

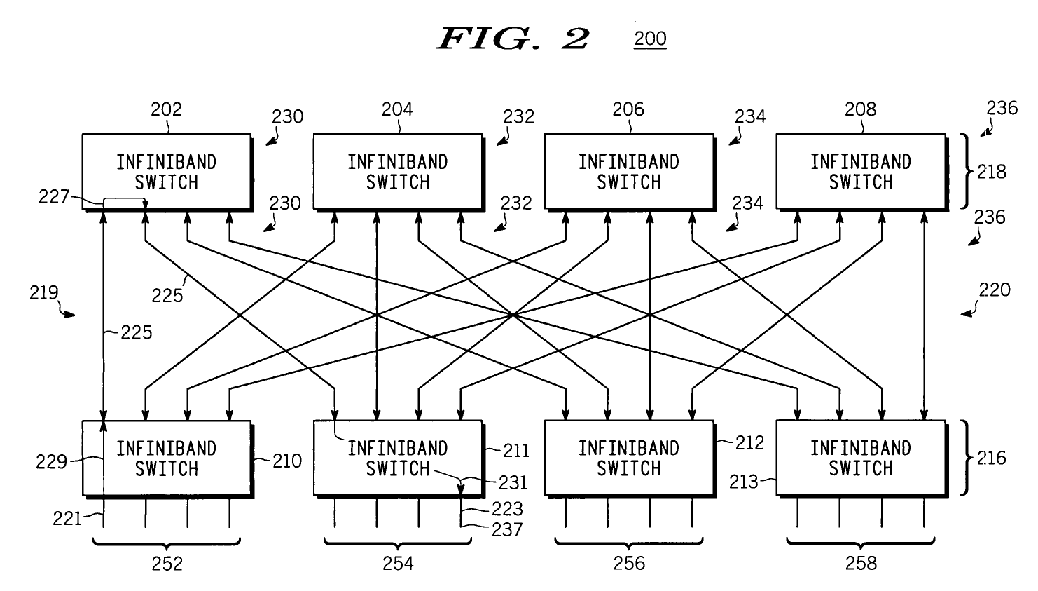

FIG. 2 depicts a network 200 according to another embodiment of the invention. As shown in FIG. 2, network 200 includes first stage InfiniBand switches 216 coupled to second stage InfiniBand switches 218 via plurality of links. In an embodiment, network 200 can be a Clos network 220 since each node in the first stage connects to each node in the second stage. In an embodiment, each of plurality of first stage InfiniBand switches 216 can be coupled to one or more of plurality of end nodes (not shown for clarity), via plurality of end node ports. For example, InfiniBand switch 210 can comprise plurality of end node ports 252, InfiniBand switch 211 can comprise plurality of end node ports 254, InfiniBand switch 212 can comprise plurality of end node ports 256, and InfiniBand switch 213 can comprise plurality of end node ports 258.

In the embodiment, depicted in FIG. 2, second stage InfiniBand switches 218 include InfiniBand switch 202, 204, 206, 208. In network 200, particularly in Clos network 220, the stage of InfiniBand switches furthest from plurality of end nodes are referred to as spine nodes. In the embodiment depicted in FIG. 2, second stage InfiniBand switches 218 can be considered spine nodes. Therefore, in this embodiment, each InfiniBand switch 202, 204, 206, 208 is a spine node.

A spanning tree is any group of nodes and links, (where nodes can be InfiniBand switches, end nodes, and the like), containing is a unique path between every pair of nodes in the network. A routing tree is a spanning tree that is rooted at a spine node that defines the shortest path tree from the spine node to each end node.

In network 200, there is a routing tree for each of second stage InfiniBand switches 218. In an embodiment, routing tree 230 includes InfiniBand switch 202, which is a spine node, and associated links to each of first stage InfiniBand switches 216 and associated inter-switch links through each of first stage InfiniBand switches 216 to each of end node ports 252, 254, 256, 258.

In an embodiment, routing tree 232 includes InfiniBand switch 204, which is a spine node, and associated links to each of first stage InfiniBand switches 216 and associated inter-switch links through each of first stage InfiniBand switches 216 to each of end node ports 252, 254, 256, 258.

In an embodiment, routing tree 234 includes InfiniBand switch 206, which is a spine node, and associated links to each of first stage InfiniBand switches 216 and associated inter-switch links through each of first stage InfiniBand switches 216 to each of end node ports 252, 254, 256, 258.

In an embodiment, routing tree 236 includes InfiniBand switch 208, which is a spine node, and associated links to each of first stage InfiniBand switches 216 and associated inter-switch links through each of first stage InfiniBand switches 216 to each of end node ports 252, 254, 256, 258.

In an illustration of an embodiment, a packet created at an end node coupled to InfiniBand switch 210 can traverse a path 225. Packet can enter InfiniBand switch 210 via end node port 221, traverse inter-switch link 229, continue on a link to InfiniBand switch 202, traverse inter-switch link 227; travel to InfiniBand switch 211, traverse inter-switch link 231, out end node port 223 to another end node. In this embodiment, the packet travels path 225 between an end node coupled to InfiniBand switch 210 and an end node coupled to InfiniBand switch 211. In an embodiment; path 225 is a shortest path 225 between spine node 202 and each of plurality of end nodes. In this embodiment, the packet traveled from a source to a destination using routing tree 230. As is known in the art, each of destinations in network 200 operating using InfiniBand has a Base Local Identifier, known as a BaseLID 237, which is analogous to an address of the destination.

In this embodiment, any packet created at a source needs a BaseLID of the destination and a routing tree to define the path to define a unique path from the source to the destination. In an embodiment, the sum of the BaseLID and the routing tree (which can be, for example, a routing tree ID) can be a Destination Local Identifier (DLID). DLID includes the destination port (as designated by BaseLID) and the path to get there from the source, where the path is identified by, for example and without limitation, a routing tree ID.

In an embodiment, network 200, can be a Clos network 220, and also a rearrangably non-blocking Clos network since the number of second stage InfiniBand switches 218 is greater than or equal to the number of end node ports on a first stage InfiniBand switch 216. In another embodiment, network 200 can be a strictly non-blocking Clos network since the number of second stage InfiniBand switches 218 equal to or greater than 2*(number of end node ports on a first stage InfiniBand switch 216)−1. In an embodiment, traffic in network 200 can be scheduled such that the only queuing delays experienced by an admissible traffic pattern are attributable to the multiplexing of packets from slow links onto a faster link whose aggregate bandwidth at least equals the sum of the bandwidths of the smaller links. In this embodiment, competing traffic sources do not attempt to use the same network resources at the same time. As defined above, network 200 can then be a SNIN 219.

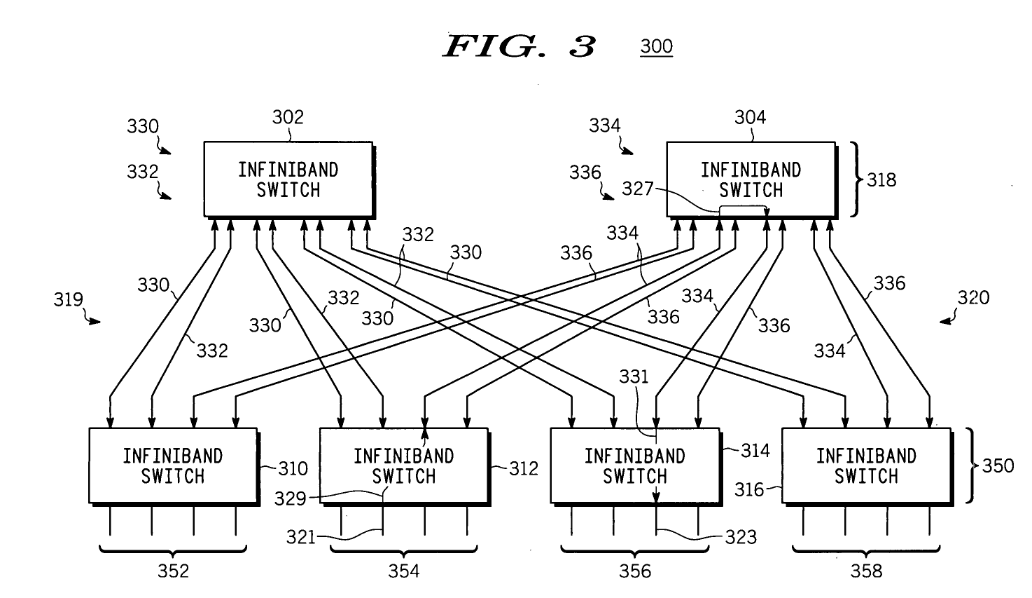

FIG. 3 depicts a network 300 according to yet another embodiment of the invention. As shown in FIG. 3, network 300 includes first stage InfiniBand switches 350 coupled to second stage InfiniBand switches 318 via plurality of links. In an embodiment, each of plurality of first stage InfiniBand switches 350 can be coupled to one or more of plurality of end nodes (not shown for clarity), via plurality of end node ports. For example, InfiniBand switch 310 can comprise plurality of end node ports 352, InfiniBand switch 311 can comprise plurality of end node ports 354, InfiniBand switch 312 can comprise plurality of end node ports 356, and InfiniBand switch 313 can comprise plurality of end node ports 358.

As is known in the art, a dilated network is one in which the total bandwidth between at least one pair of switches is greater than the bandwidth of a link connecting a switch to an end node. In an embodiment, network 300 can be a dilated network as there are two links between each of first stage InfiniBand switches 350 and second stage InfiniBand switches 318. Dilated networks are significant because they allow the cost-effective construction of non-blocking networks. Dilated network are also significant when links of differing speeds are used in the network.

In an embodiment, network 300 is equivalent to network 200, where network 300 is dilated. Therefore, network 300 is also a Clos network 320. Network 300 is more cost-effective as only two second stage InfiniBand switches 218 are required. As is known the art of networking, equivalence can be shown between network 300 and network 200. Equivalence allows a path in network 300 to be mapped back to a path in network 200, such that non-interfering traffic flows remain non-interfering. Any admissible set of connections can be carried by either of network 200 or network 300. Therefore, a dilated network such as network 300 can carry any set of connections that network 200 can. Therefore, network 300 can be rearrangably non-blocking Clos network, a strictly non-blocking Clos network and/or a SNIN 319 as was shown with reference to network 200.

In the embodiment, depicted in FIG. 3, second stage InfiniBand switches 318 include InfiniBand switch 302, 304. In network 300, particularly in Clos network 320, the stage of InfiniBand switches furthest from plurality of end nodes are referred to as spine nodes. In the embodiment depicted in FIG. 3, second stage InfiniBand switches 318 can be considered spine nodes. Therefore, in this embodiment, each InfiniBand switch 302, 304 is a spine node. In network 300, there may be multiple shortest paths between a spine node and an end node. A generalization can be made from the non-dilated case shown in FIG. 2 by defining a routing tree in such a way that is sufficient to cover all the paths for a routing tree between a spine node and the plurality of end nodes.

In network 300, there are two routing trees for each of second stage InfiniBand switches 318. In an embodiment, routing tree 330 includes InfiniBand switch 302, which is a spine node, and associated links to each of first stage InfiniBand switches 350 and associated inter-switch links through each of first stage InfiniBand switches 350 to each of end node-ports 352, 354, 356, 358.

In an embodiment, routing tree 332 includes InfiniBand switch 302, which is a spine node, and associated links to each of first stage InfiniBand switches 350 and associated inter-switch links through each of first stage InfiniBand switches 350 to each of end node ports 352, 354, 356, 358.

In an embodiment, routing tree 334 includes InfiniBand switch 304, which is a spine node, and associated links to each of first stage InfiniBand switches 350 and associated inter-switch links through each of first stage InfiniBand switches 350 to each of end node ports 352, 354, 356, 358.

In an embodiment, routing tree 336 includes InfiniBand switch 304, which is a spine node, and associated links to each of first stage InfiniBand switches 350 and associated inter-switch links through each of first stage InfiniBand switches 350 to each of end node ports 352, 354, 356, 358.

In an illustration of an embodiment, a packet created at end node coupled to InfiniBand switch 312 can traverse a path to an end node coupled to InfiniBand switch 314. Packet can enter InfiniBand switch 312 via end node port 321, traverse inter-switch link 329, continue on a link (using routing tree 334) to InfiniBand switch 304, traverse inter-switch link 327, travel to InfiniBand switch 314, traverse inter-switch link 331, out end node port 323 to another end node. In this embodiment, the packet travels the path between an end node coupled to InfiniBand switch 312 and an end node coupled to InfiniBand switch 314. In an embodiment, the path is a shortest path between spine node 304 and each of plurality of end nodes. In this embodiment, the packet traveled from a source to a destination using routing tree 334. As is known in the art, each of destinations in network 300 operating using InfiniBand has a BaseLID. The sum of the BaseLID and the routing tree (which can be, for example, a routing tree ID) can be a DLID analogous to that described above with reference to FIG. 2.

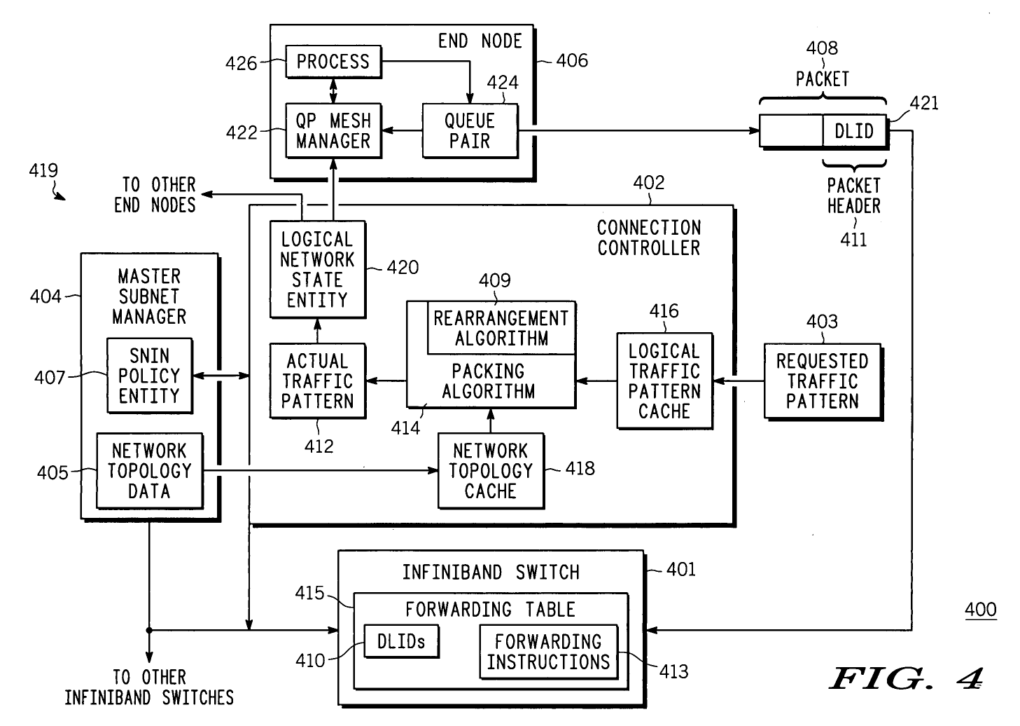

FIG. 4 depicts a block diagram of a network 400 according to an embodiment of the invention. Network 400 includes a path determination mechanism that programs forwarding tables of InfiniBand switches with paths appropriate to make network 400 operate as a SNIN 419. As shown in FIG. 4, network 400 can include one or more end nodes 406, which are representative of plurality of end nodes 114 shown in FIG. 1 and referred to in FIG. 2 and FIG. 3. End node 406 can be coupled to a connection controller 402, which is in turn coupled to master subnet manager 404. Master subnet manager 404 is also coupled to each of one or more InfiniBand switches 401, which represents any of InfiniBand switches referred to in FIGS. 1-3.

Network 400 operating using InfiniBand has one master subnet manager 404, which can reside on a port, InfiniBand switch, router, end node, and the like. In another embodiment, master subnet manager 404 can be distributed among any number of InfiniBand switches, end nodes and ports. Master subnet manager 404 can be implemented in hardware or software. When there are multiple subnet managers in network 400, one subnet manager will include master subnet manager 404 and any other subnet managers within network 400 may become a standby subnet manager. In an embodiment, master subnet manager 404 manages network 400 and can initialize and configure network 400. This can include discovering a topology of network 400, establishing possible paths among InfiniBand switches and end nodes, assigning local identifiers to each port in network 400, sweeping the network and discovering and managing changes in topology of network 400, and the like. In the realm of InfiniBand, network 400 can be considered a subnet.

In an embodiment, master subnet manager 404 can include network topology data 405, which contains data on network 400 and all paths, InfiniBand switches, end nodes, links, and the like. Master subnet manager 404 can also include SNIN policy entity, which can be a mechanism to specify whether the policy of operating network 400 as an SNIN is in effect.

In an embodiment, connection controller 402 can be a software entity responsible for receiving a requested traffic pattern 403 from one or more end nodes 406, routing connections in network 400 in a non-interfering fashion and conveying routing information to respective end nodes. In other words, connection controller 402 can receive connection requests from end nodes and amalgamate them to form requested traffic pattern 403. In an embodiment, connection controller 402 can also communicate with master subnet manager 404 to pre-program end nodes in a way that is consistent with non-interfering operation of network 400. In an embodiment, connection controller 402 can reside on a port, InfiniBand switch, router, end node, and the like. In another embodiment, connection controller 402 can be distributed among any number of InfiniBand switches, end nodes and ports.

In an embodiment, connection controller 402 can include network topology cache 418, which maintains a local representation network topology data 405. In other words, network topology cache 418 can maintain a local representation of master subnet manager's 404 view of network topology data 405, including paths established between InfiniBand switches, end nodes, and the like, of network 400. Connection controller 402 can also include logical traffic pattern cache 416, which is responsible for storing requested traffic pattern 403 received from one or more of end nodes 406.

Connection controller 402 can also include packing algorithm 414, which can combine requested traffic pattern 403 with network topology data 405 stored in network topology cache 418 to calculate actual traffic pattern 412. In an embodiment, actual traffic pattern 412 can include the set of paths that each packet in requested traffic pattern is to use in order to achieve non-interfering operation of network 400. Logical network state entity 420 stores actual traffic pattern 412 from packing algorithm 414 and communicates actual traffic pattern 412 to sources at each end node 406 included in requested traffic pattern 403.

Packing algorithm 414 can include rearrangement algorithm 409. In an embodiment, rearrangement algorithm 409 can identify how to rearrange a network so as to allow the admission of a new admissible connection in a non-interfering fashion. In an embodiment, the input to rearrangement algorithm can be a Paull matrix representing a non-interfering network state and a request to establish a new connection. The output of rearrangement algorithm can be a new Paull matrix representing a non-interfering network state in which the new connection is carried in addition to the pre-existent connections. An example of an embodiment of rearrangement algorithm 409 is Hui's rearrangement algorithm. It is desired to be understood that Hui's rearrangement algorithm is merely exemplary and that other rearrangement algorithms are included in the scope of the invention.

In some networks, such as Folded Networks, rearrangement algorithm 409 can find a path for an admissible traffic pattern. However, the resulting path may have loops in it. After determining the path for all connections, but prior to having instantiated the paths, each path can be independently pruned to remove any loops.

In a Clos network, the tuple of (source, destination, spine node) uniquely identifies every path that could potentially be selected as a consequence of rearrangement algorithm 409. The tuple (source, destination, spine node) defines the path obtained by applying loop removal to the path obtained by taking the shortest path from source to spine node followed by shortest path from spine node to destination. As described above, routing tree is a shortest-path spanning tree rooted at one of the spine nodes. The tuple (source, destination, routing tree) identifies a loop-less shortest path from source to destination contained entirely within the routing tree. This identification of a path is unique in network 400. The identification of a minimally sufficient set of routing trees to support rearrangement algorithm 409 allows programming of InfiniBand switch forwarding tables and enables the realization of network 400 as a SNIN 419. This is discussed further below.

Network 400 can include end node 406. End node 406 is representative of plurality of end nodes 114 shown in FIG. 1 and referred to in FIG. 2 and FIG. 3. End node 406 can include process 426, which can be a user process that wishes to connect with network 400, in particular SNIN 419. Process 426 can be a program, job, and the like, contained in memory on end node 406 and controlled by a processor on end node 406. End node 406 when operating using InfiniBand can include queue pair 424, which represents one half (either receive or transmit) of an InfiniBand communications process. Queue pair 424 is known in the art. End node 406 can include QP mesh manager, which can be a software entity responsible for maintaining multiple queue pairs existent on end node 406, communicating with logical network state entity 420 to receive actual traffic pattern 412 pertaining to packet 408 created at end node 406, and informing end node (as a source) which queue pair to use at any given instant in time.

Network 400 can include InfiniBand switch 401, which represents any of InfiniBand switches referred to in FIGS. 1-3. InfiniBand switch 401 can include forwarding table 415 to store, in one embodiment, set of forwarding instructions 413 and plurality of DLIDs 410. As discussed above, DLID comprises a BaseLID and reference to a routing tree (routing tree ID). In an embodiment, a packet 408 with a DLID 421 in the packet header 411, created at end node 406 acting as a source, enters InfiniBand switch 401. DLID 421 is looked up in forwarding table 415 to find corresponding one of plurality of DLIDs 410. Packet 408 is then forwarded toward a destination based on the set of forwarding instructions 413 corresponding to DLID 421.

In an embodiment, when network 400 is initialized, or when network 400 has a topology change, forwarding table 415 of each InfiniBand switch 401 can be populated with plurality of DLIDs 410 and set of forwarding instructions 413 such that network operates as a SNIN 419 if SNIN policy is in effect per SNIN policy entity 407. This can begin with connection controller calculating a plurality of routing trees for the plurality of <InfiniBand switches in network 400. Connection controller 402 can receive the topology of network 400 (network topology data 405) from master subnet manager 404 as described above. Plurality of routing trees can be calculated based on each spine node in a Clos network as described with reference to FIGS. 2 and 3.

Thereafter, a plurality of DLIDs 410 and a set of forwarding instructions 413 for each InfiniBand switch 401 can be calculated where each of the plurality of DLIDs 410 corresponds to one of the routing trees of which InfiniBand switch 401 is part and one of a plurality of destinations as referenced by a BaseLID. In an embodiment, calculating the plurality of routing trees includes, for each spine node, calculating a shortest path from the spine node to each of a plurality of sources and a plurality of destinations. The plurality of routing trees include at least a portion of the plurality of InfiniBand switches in network 400 and the corresponding plurality of links that form a shortest path from at least one of the plurality of sources or one of the plurality of destinations to the spine node of network 400. The addition of a routing tree (routing tree ID) to a BaseLID produces a DLID for a given destination. Forwarding table 415 will only use the links associated with the routing tree for that DLID.

In an embodiment, forwarding table 415 can be populated as each DLID and set of forwarding instructions is calculated. In another embodiment, each DLID and set of forwarding instructions can be sent to InfiniBand switch 401 after the plurality of DLIDs 410 and set of forwarding instructions 413 are calculated for each of plurality of InfiniBand switches in network 400.

Once forwarding table 415 is populated at each of InfiniBand switches 401 in network 400, connection controller 402 and master subnet manager 404 can be coupled to operate network 400 as a SNIN 419. Packet 408 can be created at one of a plurality of sources, where the one of the plurality of sources can be located at end node 406. Packet 408 has a destination as defined by a BaseLID of a destination in network 400. In a given time window, each source can submit to connection controller 402 the destination where it wants to send a packet. The sum of all of these requests by a plurality of sources can be requested traffic pattern 403. Connection controller 402, in particular packing algorithm 414, runs rearrangement algorithm 409 for network 400 and computes actual traffic pattern 412 using requested traffic pattern 403 and network topology data 405, such that network 400 operates as a SNIN 419. Connection controller 402 then has logical network state entity 420 communicate actual traffic pattern 412 to the source at end node 406 corresponding to packet 408. Actual traffic pattern 412 can comprise a DLID 421 assigned to packet 408 such that network 400 operates as a SNIN 419. QP mesh manager 422 at end node 406 can then assign a specific queue pair corresponding to the DLID 421.

In the given time window, once connection controller 402 has assigned DLIDs to all of the packets corresponding to the requested traffic pattern 403, packet 408 follows a path through at least a portion of plurality of InfiniBand switches 401 toward its destination. Time window, can be for example and without limitation, 1/60^{th} of a second. Each of the portion of the plurality of InfiniBand switches forwards the packet 408 according to the DLID 421 assigned to the packet 408. When packet 408 arrives at InfiniBand switch 401, the DLID 421 in packet header 411 is looked up in forwarding table 415. DLID 421 is matched with one of the plurality of DLIDs 410 in forwarding table 415 and packet 408 is forwarded out of a port on InfiniBand switch 401 to another InfiniBand switch according to set of forwarding instructions 413 corresponding to the one of the plurality of DLIDs 410 matching the DLID 421 in packet header 411. The packet will follow only the links designated in the routing tree corresponding to the DLID 421 assigned to the packet. This is repeated at each of portion of plurality of InfiniBand switches until packet 408 reaches its destination end node. The process can be repeated for each subsequent time window as long as network 400 is in operation. In another embodiment, each source can tell connection controller 402 that it wants to operate during a given time frame. In this embodiment, this data can be requested traffic pattern 403 and connection controller 402 can compute actual traffic pattern so that network 400 operates as SNIN 419.

The above process of populating forwarding tables of InfiniBand switches with paths appropriate to make network 400 operate as a SNIN 419 works particularly well for a Clos network. However, as a Clos network is instantiated, it is unlikely that all InfiniBand switches will be turned on simultaneously. As such network 400 can pass through states in which it is not a Clos network. Therefore the above methodology can be implemented in a non-Clos network as well, where the populating of forwarding tables occurs after each change in topology of network 400.

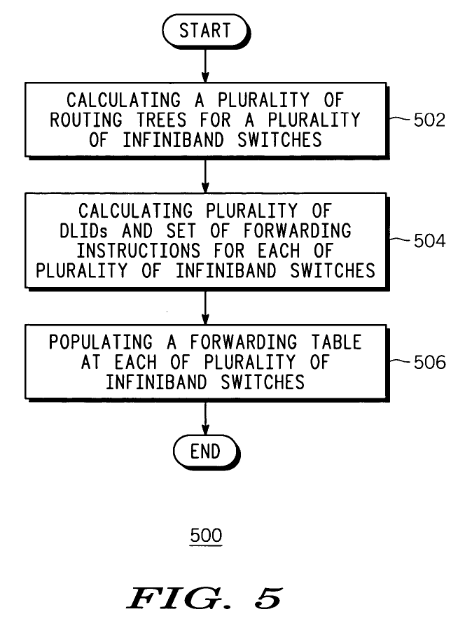

FIG. 5 illustrates a flow diagram 500 of a method of the invention according to an embodiment of the invention. In step 502, a plurality of routing trees are calculated for a plurality of InfiniBand switches in a network. In an embodiment, calculating the plurality of routing trees comprises for each spine node in the network, calculating a shortest path from the spine node to each of the plurality of sources and each of the plurality of destinations. In an embodiment, the network is a Clos network. Each of the plurality of routing trees can comprise at least a portion of the plurality of InfiniBand switches and corresponding plurality of links that form a shortest path from one of the plurality of sources or one of the plurality of destinations to a spine node of the Clos network.

In step 504, a plurality of DLIDs and a set of forwarding instructions are calculated for each of the plurality of InfiniBand switches, wherein each of the plurality of DLIDs corresponds to one of the plurality of routing trees and one of a plurality of destinations. In step 506, a forwarding table of each of the plurality of InfiniBand switches in the Clos network is populated with the plurality of DLIDs and the set of forwarding instructions.

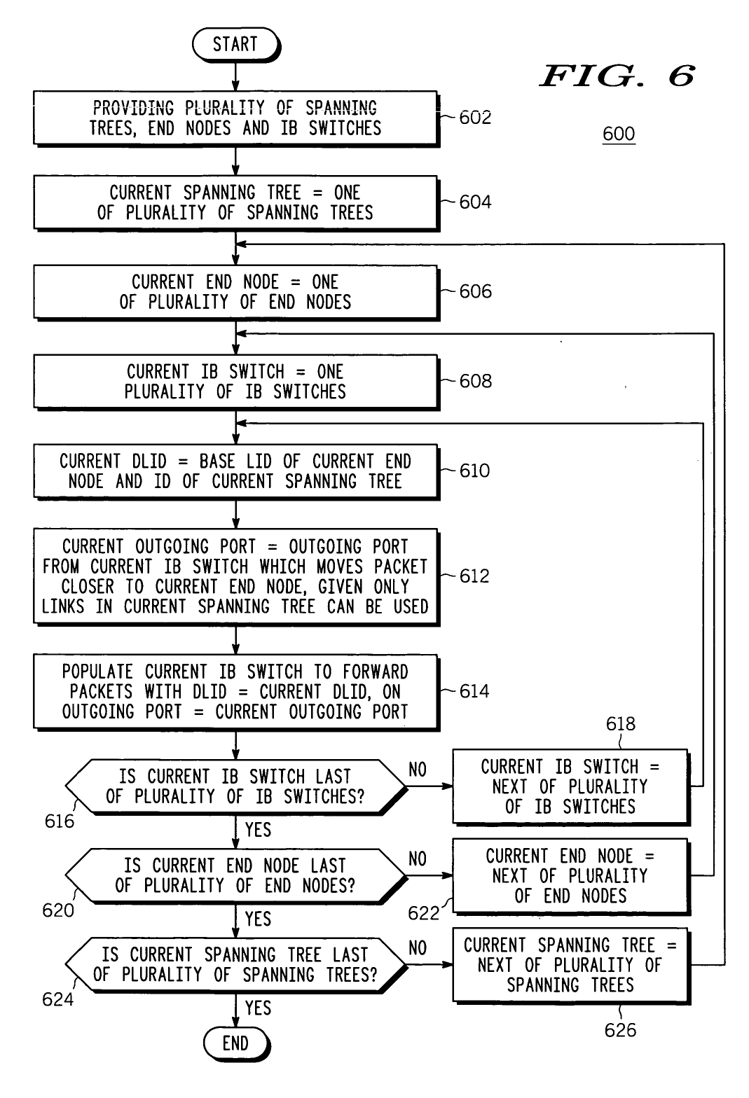

FIG. 6 illustrates a flow diagram 600 of a method of the invention according to another embodiment of the invention. In an embodiment, the method illustrated in FIG. 6 illustrates one embodiment for calculating a plurality of routing trees from a plurality of spanning trees and programming and populating forwarding tables at a plurality of InfiniBand switches with DLIDs and corresponding sets of forwarding instructions such that a network can operate as a SNIN. The method is particularly suited to, but not limited to, rearrangably, non-blocking, multistage Clos networks.

In step 602, a plurality of end nodes, InfiniBand switches and links define a plurality of spanning trees. In step 604, one of the plurality of spanning trees is selected as the current spanning tree. In step 606, one of the plurality of end nodes is selected as the current end node. In step 608, one of the plurality of InfiniBand (IB) switches is selected as the current InfiniBand switch.

In step 610, the current DLID is calculated to be the BaseLID of the current end node plus the tree ID of the current spanning tree. In step 612, the current outgoing port is set equal to the outgoing port from the current InfiniBand switch which moves a packet closer to the current end node, given that only links in the current spanning tree can be used. Step 614 represents one embodiment of the invention that includes populating the current InfiniBand switch's forwarding tables such that the current InfiniBand switch forwards packets with the DLID equaling the current DLID, on an outgoing port equal to the current outgoing port. In another embodiment, of the invention, step 614 is not included and an additional step at the end of the flow diagram in FIG. 6 is included to populate the forwarding tables with a plurality of DLIDs and a-set of forwarding instructions. In other words, in this alternate embodiment, the forwarding tables are populated only after the plurality of routing trees, plurality of DLIDs and set of forwarding instructions are all calculated.

In step 616, it is determined if the current InfiniBand switch is the last of the plurality of InfiniBand switches. If not, the current InfiniBand switch is set equal to the next of the plurality of InfiniBand switches per step 618 and the process returns to step 610. This process repeats until, in step 616, the current InfiniBand switch is the last of the plurality of InfiniBand switches, at which time the process moves to step 620. In other words, for a given spanning tree and a given end node, each InfiniBand switch in the network is processed per steps 610-614.

In step 620, it is determined if the current end node is the last of the plurality of end nodes. If not, the current end node is set equal to the next of the plurality of end nodes per step 622 and the process returns to step 608. This process repeats until, in step 620, the current end node is the last of the plurality of end nodes, at which time the process moves to step 620. In other words, for a given spanning tree, each end node in the network is processed per steps 610-614.

In step 624, it is determined if the current spanning tree is the last of the plurality of spanning trees. If not, the current spanning tree is set equal to the next of the plurality of spanning trees per step 626 and the process returns to step 606. This process repeats until, in step 624, the current spanning tree is the last of the plurality of spanning trees, at which time the process of FIG. 6 is completed. At the completion of the process of FIG. 6, the forwarding tables of each of the plurality of InfiniBand switches is populated with a plurality of DLIDs and the set of forwarding instructions such that a packet arriving at an InfiniBand switch can be forwarded such that the network operates as a SNIN.

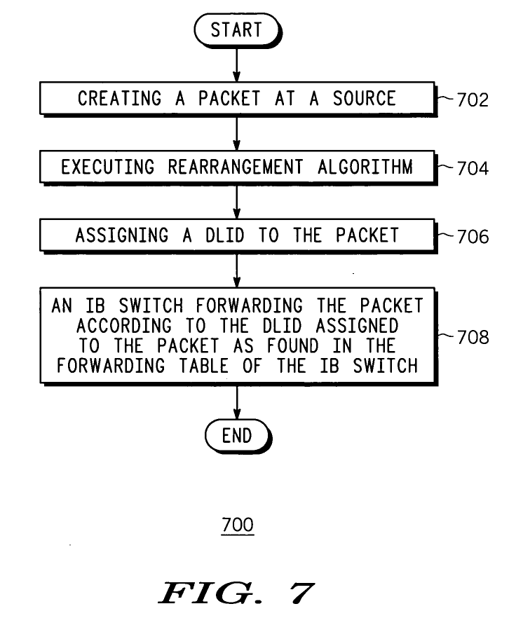

FIG. 7 illustrates a flow diagram of a method of the invention according to yet another embodiment of the invention. In step 702, a packet is created at a source in a network, wherein the packet is addressed to a destination. Step 704 includes executing a rearrangement algorithm for the network. Step 706 includes assigning one of a plurality of DLIDs to the packet. Step 708 includes the packet following a path through at least a portion of a plurality of InfiniBand switches from the one of the plurality of sources to the one of the plurality of destinations, wherein each of the portion of the plurality of InfiniBand switches forward the packet according to the one of the plurality of DLIDs assigned to the packet. Step 708 includes looking up the one of the plurality of DLIDs assigned to the packet in the forwarding table at each of the portion of the plurality of InfiniBand switches along the path from the source to the destination. In other words, each of the portion of the plurality of InfiniBand switches forwards the packet in accordance with the one of the plurality of DLIDs assigned to the packet as found in the forwarding table at each the portion of the plurality of InfiniBand switches.

While we have shown and described specific embodiments of the present invention, further modifications and improvements will occur to those skilled in the art. It is therefore, to be understood that appended claims are intended to cover all such modifications and changes as fall within the true spirit and scope of the invention.

1. A connection controller, comprising:
a network topology cache coupled to receive network topology data of a network;
a packing algorithm coupled to receive a requested traffic pattern of a packet, wherein the packing algorithm computes an actual traffic pattern using the network topology data and the requested traffic pattern such that the network operates as a strictly non-interfering network; and
a logical network state entity coupled to communicate the actual traffic pattern to a source corresponding to the packet.

2. The connection controller of claim 1, wherein the connection controller calculates a plurality of routing trees for a plurality of InfiniBand switches in the network, wherein the connection controller calculates a plurality of DLIDs and a set of forwarding instructions for each of the plurality of InfiniBand switches, wherein each of the plurality of DLIDs corresponds to one of the plurality of routing trees and one of a plurality of destinations in the network, and wherein the connection controller populates a forwarding table of each of the plurality of InfiniBand switches with the plurality of DLIDs and the set of forwarding instructions.

3. The connection controller of claim 1, wherein computing an actual traffic pattern comprises executing a rearrangement algorithm and assigning one of a plurality of DLIDs to the packet such that the network operates as a strictly non-interfering network.

4. The connection controller of claim 3, wherein the packet follows a path through at least a portion of a plurality of InfiniBand switches in the network, and wherein each of the portion of the plurality of InfiniBand switches forwards the packet according to the one of the plurality of DLIDs assigned to the packet such that the network operates as a strictly non-interfering network.

5. The connection controller of claim 4, wherein each of the portion of the plurality of InfiniBand switches looks up the one of the plurality of DLIDs assigned to the packet in a forwarding table at each of the portion of the plurality of InfiniBand switches.

6. The connection controller of claim 4, wherein each of the portion of the plurality of InfiniBand switches forwards the packet in accordance with the one of the plurality of DLIDs assigned to the packet as found in a forwarding table at each the portion of the plurality of InfiniBand switches.

7. The connection controller of claim 1, wherein the network is a Clos network.

8. A connection controller comprising a computer-readable medium containing computer instructions for instructing a processor to perform a method of populating a forwarding table, the instructions comprising:
calculating a plurality of routing trees for a plurality of InfiniBand switches in a network;
calculating a plurality of DLIDs and a set of forwarding instructions for each of the plurality of InfiniBand switches, wherein each of the plurality of DLIDs corresponds to one of the plurality of routing trees and one of a plurality of end nodes; and
populating the forwarding table of each of the plurality of InfiniBand switches in the network with the plurality of DLIDs and the set of forwarding instructions.

9. The connection controller of claim 8, wherein the network is a Clos network.

10. The connection controller of claim 8, wherein each of the plurality of end nodes comprises a destination, and wherein the destination is identified by a BaseLID.

11. The connection controller of claim 8, wherein calculating the plurality of routing trees comprises for each spine node in the network, calculating a shortest path from the spine node to each of the plurality of end nodes.

12. The connection controller of claim 8, wherein each of the plurality of routing trees comprises at least a portion of the plurality of InfiniBand switches and corresponding plurality of links that form a shortest path from one of the plurality of end nodes to a spine node of the network.

13. A connection controller comprising a computer-readable medium containing computer instructions for instructing a processor to perform a method of forwarding a packet, wherein the packet is created at a source and is addressed to a destination within a network, the instructions comprising:
executing a rearrangement algorithm for the network;
assigning one of a plurality of DLIDs to the packet; and
the packet following a path through at least a portion of a plurality of InfiniBand switches from the source to the destination, wherein each of the portion of the plurality of InfiniBand switches forward the packet according to the one of the plurality of DLIDs assigned to the packet.

14. The connection controller of claim 13, wherein the network operates as a strictly non-interfering network.

15. The connection controller of claim 13, wherein the network is a Clos network.

16. The connection controller of claim 13, wherein the packet following the path comprises looking up the one: of the plurality of DLIDs assigned to the packet in a forwarding table at each of the portion of the plurality of InfiniBand switches along the path from the source to the destination.

17. The connection controller of claim 13, wherein the packet following the path comprises each of the portion of the plurality of InfiniBand switches forwarding the packet in accordance with the one of the plurality of DLIDs assigned to the packet as found in a forwarding table at each the portion of the plurality of InfiniBand switches.
